(19) United States
(12) Patent Application Publication
(10) Pub. No.: US 2025/0373003 A1
(43) Pub. Date: Dec. 4, 2025

(54) Protection circuit for a three-phase power supply system

(71) Applicant: Schneider Electric Industries SAS, Rueil Malmaison (FR)

(72) Inventor: Eloïse BONJEAN, Le mottier (FR)

(21) Appl. No.: 19/226,639

(22) Filed: Jun. 3, 2025

(30) Foreign Application Priority Data
Jun. 4, 2024 (FR) FR2405826

(51) Int. Cl. H02H 3/34; H02H 5/04

(52) U.S. Cl. CPC H02H 3/34; H02H 5/047

(57) ABSTRACT

The invention relates to a protection circuit (2) for a medium-voltage power supply system (4), the power supply system having three phase lines (L1, L2, L3), the protection circuit comprising:
at least three first current transformers (10, 12, 14), the first current transformers (10, 12, 14) each having a primary side and a secondary side, the primary side of each first current transformer being coupled to a different phase line (L1, L2, L3),
at least three second current transformers (16, 18, 20), the second current transformers each having a primary side and a secondary side, the primary sides of the second current transformers being connected to the secondary sides of the first current transformers,
at least two thermofuses (28), the thermofuses (28) each being connected in parallel to the primary sides of the second current transformers.

### TECHNICAL FIELD OF THE INVENTION

The present invention relates to a protection circuit for a medium-voltage power supply system using a tripping actuator.

### PRIOR ART

FR 2 414 810 discloses a protective relay installation for a polyphase distribution circuit. However, this installation includes an additional current transformer. In addition, the trigger circuit of this installation must be permanently powered by an additional external power source. Finally, in this installation, a current flows permanently in the current transformers.

Document EP 2 079 140 discloses a protection circuit comprising three current transformers each coupled directly to a phase line and three fuses connected between the output terminals of the current transformer.

However, this protection circuit comprises large-volume current transformers coupled to the phase lines.

To reduce costs, it is desired to use low-power, small-volume current transformers. These transformers cannot deliver such a high power, this hindering their use with the chains of the known components of the tripping actuators.

Additionally, this circuit does not detect ground faults.

It is also known to have two or more electromagnets in the chain of the components of the tripping actuator in order to trip the switching of the power supply system, this taking up space within these components.

Finally, the number of fuse variants necessary to cover the range of triggering characteristics desired by users is generally high.

### PRESENTATION OF THE INVENTION

A first object of the present invention is to propose a compact protection circuit, in particular by using low-consumption bushing transformers coupled to the phases.

A second object of the present invention is to reduce the number of fuse variants in order to simplify the operation of the power supply system.

A third object of the present invention is to propose a protection circuit having a low manufacturing cost and having low electrical consumption.

A fourth object of the present invention is to propose a reliable and robust protection circuit.

### SUMMARY OF THE INVENTION

The present invention relates to a protection circuit for a medium-voltage power supply system, the power supply system having a first phase line, a second phase line and a third phase line, the protection circuit comprising:
a first bushing current transformer having a primary side coupled to the first phase line, and a secondary side,
a second bushing current transformer having a primary side coupled to the second phase line, and a secondary side,
a third bushing current transformer having a primary side coupled to the third phase line, and a secondary side,
a first overcurrent current transformer having a primary side connected to the secondary side of the first bushing current transformer, and a secondary side,
a second overcurrent current transformer having a primary side connected to the secondary side of the third bushing current transformer, and a secondary side,
a earth fault current transformer having a primary side connected to the secondary side of the second bushing current transformer, and a secondary side,
a first fuse connected in parallel to the primary side of the first overcurrent current transformer and a second fuse connected in parallel to the primary side of the second overcurrent current transformer.

Advantageously, this protection circuit works with fuses of small size, low cost and which are easy to change because they do not require intervention on the medium-voltage side of the cell.

Advantageously, the first overcurrent current transformer, the second overcurrent current transformer and the earth-fault current transformer perform current matching and voltage matching between the secondaries of the bushing current transformers and the input of the tripping actuator.

Advantageously, in the protection circuit according to the invention, a current flows in the overcurrent current transformers only in the event of a phase fault.

The features disclosed in the following paragraphs may, optionally, be implemented. They may be implemented independently of one another or in combination with one another:
The secondary side of the first bushing current transformer comprises a first output terminal which is connected to a first connection point, the secondary side of the second bushing current transformer comprises a first output terminal which is connected to the first connection point, the secondary side of the third bushing current transformer comprises a first output terminal which is connected to the first connection point.
The first connection point is connected to at least one earth terminal among a first earth terminal a second earth terminal and a second earth terminal.
The primary side of the first overcurrent current transformer comprises a downstream terminal, the primary side of the second overcurrent current transformer comprises a downstream terminal, the primary side of earth-fault current transformer comprises an upstream terminal; the downstream terminal of the primary side of the first overcurrent current transformer is connected the downstream terminal of the primary side of the second overcurrent current transformer and to the upstream terminal of the primary side of earth-fault current transformer, at a second connection point and in a star configuration.

Advantageously, the protection circuit detects overcurrent faults and earth faults.
The second connection point is located downstream of the first overcurrent current transformer, downstream of the second overcurrent current transformer and upstream of the earth fault current transformer.
The primary side of the earth fault current transformer comprises a downstream terminal electrically connected to the first connection point.
The protection circuit comprises a single tripping actuator configured to trip a circuit breaker, and a first current rectifiers (38), a second current rectifier and a third current rectifier; the first current rectifier being connected at input to the secondary side of the first overcurrent current transformer, the second current rectifier being connected at input to the secondary side of the earth-fault current transformer, the third current rectifier being connected at input to the secondary side of the second overcurrent current transformer, the first current rectifier, the second current rectifier and the third current rectifier being connected at output to said tripping actuator.
The first overcurrent current transformer is configured to clip the magnitude of the current at the output of the first bushing current transformer, the second overcurrent current transformer is configured to clip the magnitude of the current at the output of the second bushing current transformer, and the earth-fault current transformer is configured to clip the magnitude of the current at the output of the third first bushing current transformer.
The first overcurrent current transformer, the second overcurrent current transformer and the earth-fault current transformer have each a saturation voltage of between one and two times the operating voltage of the tripping actuator.
The first fuse and the second fuse are chosen from fuses having a rated current chosen from 3 Amperes, 5 Amperes and 7.5 Amperes.

Advantageously, the protection circuit can operate over a wide voltage range with a reduced number of fuse references.

Advantageously, the diameter of the electric wires is smaller. Advantageously, there is less power loss in the components of the circuit. Advantageously, the protection circuit is less expensive.
The ratios of number of windings between the primary side and the secondary side of the first bushing current transformer, between the primary side and the secondary side the second bushing current transformer and between the primary side and the secondary side the third bushing current transformer, are 50/5, 100/5 and 200/5.

Advantageously, the overcurrent current transformers and the earth-fault current transformer perform a function of clipping the currents entering the transformers.

Advantageously, the number of windings of the bushing current transformers is reduced.

Advantageously, the production cost of the secondary of the bushing transformers is reduced.

Advantageously, the overcurrent current transformers and the earth-fault current transformer do not comprise specific windings for the tripping actuator. This results in greater compactness at a location where the available space is reduced, in particular because of the insulation between the medium-voltage and low-voltage parts.
The protection circuit comprises a first resistor connected in parallel at the input of the first current rectifier, a second resistor connected in parallel at the input of the second current rectifier and a third resistor connected in parallel at the input of the third current rectifier.

The invention also relates to an electrical circuit comprising:
a medium-voltage power supply system, the power supply system having a first phase line, a second phase line and a third phase line,
a circuit breaker configured to switch the current on the first phase line, on the second phase line and on the third phase line,
a protection circuit as mentioned in the above features.

### BRIEF DESCRIPTION OF THE FIGURES

FIG. 1 is a schematic view of an electrical circuit according to the invention.

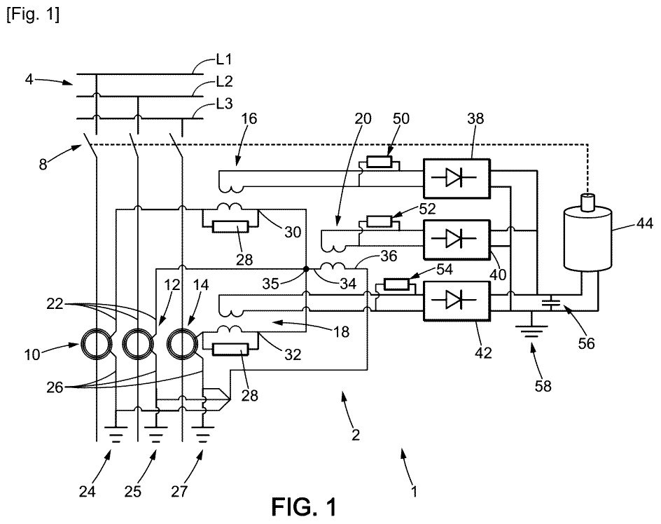

### DETAILED DESCRIPTION OF THE INVENTION

In the present description, the terms “upstream” and “downstream” are to be interpreted according to the direction of the current in the protection circuit. The invention relates to an electrical circuit 1 and a protection circuit 2. With reference to the single figure, the electrical circuit 1 comprises a power supply system 4, a protection circuit 2 coupled to the power supply system 4 and a circuit breaker 8 configured to switch the current on the power supply system 4.

The power supply system 4 is a medium-voltage power supply system.

The term “medium voltage” refers to voltages above 1 kV and below 52 kV. The power supply system 4 is configured to carry a three-phase alternating current. For this purpose, the power supply system 4 has a first phase line L1, a second phase line L2 and a third phase line L3.

The circuit breaker 8 is connected to the three phase lines upstream of the protection circuit 2. In the embodiment illustrated in the figure and in no way limiting, the circuit breaker 8 comprises three contacts each connected to a phase line.

The protection circuit 2 is connected downstream of the power supply system 4. The protection circuit 2 comprises a first bushing current transformer 10, a second bushing current transformer 12 and a third bushing current transformer 14. The first bushing current transformer 10, the second bushing current transformer 12 and the third bushing current transformer 14 have each a medium-voltage side, called the primary side, and a low-voltage side, called the secondary side.

The primary side of the first bushing current transformer 10 is coupled to the first phase line L1 of the power supply system. The primary side of the second bushing current transformer 12 is coupled to the second phase line L2 of the power supply system. The primary side of the third bushing current transformer 14 is coupled to the third phase line L3 of the power supply system.

The secondary side of the first bushing current transformer 10 comprises a first output terminal 61 which is connected to a first connection point 60. The secondary side of the second bushing current transformer 12 comprises a first output terminal 62 which is connected to the first connection point 60. The secondary side of the third bushing current transformer 14 comprises a first output terminal 63 which is connected to the first connection point 60.

The protection circuit 2 further comprises a first overcurrent current transformer 16, a second overcurrent current transformer 18 and an earth-fault current transformer 20, a first earth terminal 24, a second earth terminal 25, a third earth terminal 27, a first fuse 28A and a second fuse 28B.

The first connection point 60 is connected to at least one earth terminal among the first earth terminal 24, the second earth terminal 25 and the third earth terminal 27.

The first overcurrent current transformer 16, the second overcurrent current transformer 18 and the earth-fault current transformer 20 have each a primary side and a secondary side.

The first overcurrent current transformer 16 is connected to the first bushing current transformer 10. The second overcurrent current transformer 18 is connected to the third bushing current transformer 14. The earth-fault current transformer 20 is connected to the second bushing current transformer 12.

A second output terminal 22 on the secondary side of the first bushing current transformer 10 is connected to the primary side of the first overcurrent current transformer 16. The first output terminal 61 on the secondary side of the first bushing current transformer 10 is connected to the first ground terminal 24.

A second output terminal 22 on the secondary side of the second bushing current transformer 12 is connected to the primary side of the earth-fault current transformer 20. The second output terminal 62 on the secondary side of the second bushing current transformer 12 is connected to the second earth terminal 25.

A second output terminal 22 on the secondary side of the third bushing current transformer 14 is connected to the primary side of the second overcurrent current transformer 18. The first output terminal 63 on the secondary side of the third bushing current transformer 14 is connected to the third ground terminal 27.

The first overcurrent current transformer 16 and the second overcurrent current transformer 18 are capable of detecting an overcurrent. Therefore, they are referred to as first overcurrent current transformer 16 and second overcurrent current transformer 18 respectively. The earth fault current transformer 20 is capable of detecting an earth fault. Therefore, it is referred to as the earth-fault transformer 20. A first fuse 28A is connected in parallel to the primary side of the first overcurrent current transformer 16. The second fuse 28B is connected in parallel to the primary side of the second overcurrent current transformer 18.

The primary side of the first overcurrent current transformer 16 comprises a downstream terminal 30. The primary side of the second overcurrent current transformer 18 comprises a downstream terminal 32. The primary side of the earth-fault current transformer 20 comprises an upstream terminal 34. The primary side of the earth-fault current transformer 20 comprises a downstream terminal 36 which is electrically connected to the first connection point 60.

The downstream terminal 30 on the primary side of the first overcurrent current transformer 16 is connected to the downstream terminal 32 of the second overcurrent transformer 18 and to the upstream terminal 34 of the primary side of the second earth-fault current transformer 20 at a connection point 35 in a star configuration. The downstream terminal 36 on the primary side of the second earth-fault current transformer 20 is electrically connected to the first earth terminal 24, the second earth terminal 25 and the third earth terminal 27.

The second connection point 35 is located downstream of the first overcurrent current transformer 16, downstream of the second overcurrent current transformer 18 and upstream of the earth fault current transformer 20.

The first overcurrent current transformer 16, the second overcurrent current transformer 18 and the earth-fault current transformer 20 are configured to clip the magnitude of the current at the output of the first bushing current transformer, the second bushing current transformer 12 and respectively the third bushing current transformer 14.

In particular, the first overcurrent current transformer 16, the second overcurrent current transformer 18 and the earth-fault current transformer 20 have a saturation voltage on the secondary of between one and two times the operating voltage of the tripping actuator.

For example, the first overcurrent current transformer 16, the second overcurrent current transformer 18 and the earth-fault current transformer 20 have a saturation voltage on the secondary of between one and two times the operating voltage of the tripping actuator. For example, the saturation voltage is between 4 Volts and 8 Volts. Finally, the protection circuit 2 comprises a first current rectifier 38, a second current rectifier 40, a third current rectifier 42 and a tripping actuator 44. The first current rectifier 38 is connected at input to the secondary side of the first overcurrent current transformer 16 and at output to the tripping actuator 44. The second current rectifier 40 is connected at input to the secondary side of the earth-fault overcurrent current transformer 20 and at output to the tripping actuator 44. The third current rectifier 42 is connected at input to the secondary side of the second overcurrent current transformer 18 and at output to the tripping actuator 44.

Preferably, the first current rectifier 38, the second current rectifier 40 and the third current rectifier 42 are configured to clip the voltage and thus limit the power transmitted thereto. Advantageously, this clipping makes it possible to ensure that the tripping actuator will not be damaged in the event of a short circuit on the primary of the transformers.

The first current rectifier 38, the second current rectifier 40 and the third current rectifier 42 are, for example, composed of diode bridges. Preferably, the diode bridges comprise Schottky diodes.

The tripping actuator 44 is capable of tripping the circuit breaker 8. The tripping actuator 44 is, for example, an electromagnet tripping actuator. Advantageously, the protection circuit 8 comprises a single tripping actuator. Thus, the protection circuit is less bulky and less expensive.

Preferably, the protection circuit 2 comprises a first resistor 50 connected in parallel at the input of the first rectifier 38, a second resistor 52 connected in parallel at the input of the second rectifier 40 and a third resistor 54 connected in parallel at the input of the third rectifier 42.

Advantageously, the first resistor 50, the second resistor 52 and the third resistor 54 make it possible to limit overvoltages and fine-tune the level of the tripping threshold. Preferably, the protection circuit 2 further comprises a capacitor 56 connected in parallel with the tripping actuator.

Preferably, the protection circuit 2 comprises an earth terminal 58 connected to the negative terminal of the tripping actuator.

Preferably, the ratios of number of windings between the primary side and the secondary side of the first bushing current transformer 10, between the primary side and the secondary side the second bushing current transformer 12 and between the primary side and the secondary side the third bushing current transformer 14, are 50/5, 100/5 and 200/5.

During normal operation, when a medium-voltage alternating current is carried by the first phase line L1, the second phase line L2 and the third phase line L3, an alternating current is transmitted to the first overcurrent current transformer 16, to the second overcurrent current transformer 18 and to the earth-fault current transformer 20 via the first bushing current transformer 10, the second bushing current transformer 12 and respectively the third bushing current transformer 14. The current on the primary has an amplitude of approximately 5 Amperes. This current mainly flows through the first fuse 28A and the second fuse 28B. A residual current of small amplitude is transmitted to the secondary side of the first overcurrent current transformer 16, to the secondary side of the second overcurrent current transformer 18 and to the secondary side of the earth-fault current transformer 20. This current is rectified by the first current rectifier 38, the second current rectifier 40 and the third current rectifier 42. This residual current has a very low amplitude. This amplitude is well below the tripping threshold of the tripping actuator 44. The circuit breaker 8 is not tripped.

In the event of a short circuit on one of the first phase line L1, the second phase line L2 or the third phase line L3, a high-amplitude current is transmitted to the primary side of at least one current transformer among the first overcurrent current transformer 16 and the second overcurrent current transformer 18, and to at least one of the first fuse 28A and the second fuse 28B.

This current has a magnitude of greater than the rated current of the first fuse 28A and/or the rated current of the second fuse 28B, as a result of which the first fuse 28A and/or the second fuse 28B melt. The resistance of the first fuse 28A and/or the resistance of the second fuse 28B increases.

The magnitude of the current transmitted to the secondary side of the first overcurrent current transformer 16 and/or to the secondary side of the second overcurrent current transformer 18 increases.

This high-magnitude current is rectified by the first current rectifier 38 and/or the third current rectifier 42. It is greater than the tripping threshold of the tripping actuator 44. The tripping actuator 44 trips the circuit breaker 8.

In the event of an earth-fault on the first phase line L1, the second phase line L2 or the third phase line L3, the currents arriving at the connection point 35 no longer have the same amplitude. The system is no longer balanced. A current flows on the line connecting the connection point 35 to the first earth output terminal 24. A current is transmitted to the secondary side of the earth-fault current transformer 20. This current is rectified by the second current rectifier 40. This current is then transmitted to the tripping actuator 44 and causes the circuit breaker 8 to trip.

1. A protection circuit (2) for a medium-voltage power supply system (4), the power supply system having a first phase line (L1), a second phase line (L2) and a third phase line (L3), the protection circuit comprising:
a first bushing current transformer (10) having a primary side coupled to the first phase line, and a secondary side,
a second bushing current transformer (12) having a primary side coupled to the second phase line, and a secondary side,
a third bushing current transformer (14) having a primary side coupled to the third phase line, and a secondary side,
a first overcurrent current transformer (16) having a primary side connected to the secondary side of the first bushing current transformer (10), and a secondary side,
a second overcurrent current transformer (18) having a primary side connected to the secondary side of the third bushing current transformer (14), and a secondary side,
an earth fault current transformer (20) having a primary side connected to the secondary side of the second bushing current transformer (12), and a secondary side,
a first fuse (28A) connected in parallel to the primary side of the first overcurrent current transformer (16), and a second fuse (28B) connected in parallel to the primary side of the second overcurrent current transformer (16).

2. The protection circuit (2) according to claim 1, wherein the secondary side of the first bushing current transformer (10) comprises a first output terminal (61) which is connected to a first connection point (60), the secondary side of the second bushing current transformer (12) comprises a first output terminal (62) which is connected to the first connection point (60), the secondary side of the third bushing current transformer (14) comprises a first output terminal (63) which is connected to the first connection point (60).

3. The protection circuit (2) according to claim 2, wherein the first connection point (60) is connected to at least one earth terminal among a first earth terminal (24) a second earth terminal (25) and a second earth terminal (27).

4. The protection circuit (2) according to claim 1, wherein the primary side of the first overcurrent current transformer (16) comprises a downstream terminal (30), the primary side of the second overcurrent current transformer (18) comprises a downstream terminal (32), the primary side of earth fault current transformer (20) comprises an upstream terminal (34); the downstream terminal (30) of the primary side of the first overcurrent current transformer is connected the downstream terminal (32) of the primary side of the second overcurrent current transformer and to the upstream terminal (34) of the primary side of earth fault current transformer, at a second connection point (35) and in a star configuration.

5. The protection circuit (2) according to claim 4, wherein the second connection point (35) is located downstream of the first overcurrent current transformer (16), downstream of the second overcurrent current transformer (18) and upstream of the earth fault current transformer (20).

6. The protection circuit (2) according to claim 2, wherein the primary side of the earth fault current transformer (20) comprises a downstream terminal (36) electrically connected to the first connection point (60).

7. The protection circuit (2) according to claim 1, which comprises a single tripping actuator (44) configured to trip a circuit breaker (8), and a first current rectifier (38), a second current rectifier (40) and a third current rectifier (42); the first current rectifier (38) being connected at input to the secondary side of the first overcurrent current transformer (16), the second current rectifier (40) being connected at input to the secondary side of the earth fault current transformer (20), the third current rectifier (42) being connected at input to the secondary side of the second overcurrent current transformer (18), the first current rectifier (38), the second current rectifier (40) and the third current rectifier (42) being connected at output to said tripping actuator (44).

8. The protection circuit (2) according to claim 1, wherein the first overcurrent current transformer (16) is configured to clip a magnitude of the current at an output of the first bushing current transformer (10), the second overcurrent current transformer (18) is configured to clip the magnitude of the current at the output of the second bushing current transformer (12), and the earth fault current transformer (20) is configured to clip the magnitude of the current at the output of the third bushing current transformer (14).

9. The protection circuit (2) according claim 7, wherein the first overcurrent current transformer (16), the second overcurrent current transformer (18) and the earth fault current transformer (20) have each a saturation voltage of between one and two times an operating voltage of the tripping actuator.

10. The protection circuit (2) according to claim 1, wherein the first use (28A) and the second use (28B) are chosen from fuses having a rated current chosen from 3 Amperes, 5 Amperes and 7.5 Amperes.

11. The protection circuit (2) according to claim 1, wherein the ratios of number of windings between the primary side and the secondary side of the first bushing current transformer (10), between the primary side and the secondary side the second bushing current transformer (12) and between the primary side and the secondary side the third bushing current transformer (14), are 50/5, 100/5 and 200/5.

12. The protection circuit (2) according to claim 7, which comprises a first resistor (50) connected in parallel at an input of the first current rectifier (38), a second resistor (52) connected in parallel at an input of the second current rectifier (40), a third resistor (54) connected in parallel at an input of the third current rectifier (42).

13. An electrical circuit (1) comprising:
a medium-voltage power supply system (4), the power supply system having a first phase line (L1), a second phase line (L2) and a third phase line (L3),
a circuit breaker (8) configured to switch a current on the first phase line (L1), on the second phase line (L2) or on the third phase line (L3), and
a protection circuit (2) comprising:
a first bushing current transformer (10) having a primary side coupled to the first phase line, and a secondary side,
a second bushing current transformer (12) having a primary side coupled to the second phase line, and a secondary side,
a third bushing current transformer (14) having a primary side coupled to the third phase line, and a secondary side,
a first overcurrent current transformer (16) having a primary side connected to the secondary side of the first bushing current transformer (10), and a secondary side,
a second overcurrent current transformer (18) having a primary side connected to the secondary side of the third bushing current transformer (14), and a secondary side,
an earth fault current transformer (20) having a primary side connected to the secondary side of the second bushing current transformer (12), and a secondary side, and
a first fuse (28A) connected in parallel to the primary side of the first overcurrent current transformer (16), and a second fuse (28B) connected in parallel to the primary side of the second overcurrent current transformer (16),
wherein the primary side of the first overcurrent current transformer (16) comprises a downstream terminal (30), the primary side of the second overcurrent current transformer (18) comprises a downstream terminal (32), the primary side of earth fault current transformer (20) comprises an upstream terminal (34); the downstream terminal (30) of the primary side of the first overcurrent current transformer is connected the downstream terminal (32) of the primary side of the second overcurrent current transformer and to the upstream terminal (34) of the primary side of earth fault current transformer, at a second connection point (35) and in a star configuration.

14. The electrical circuit (1) according to claim 13, wherein the second connection point (35) is located downstream of the first overcurrent current transformer (16), downstream of the second overcurrent current transformer (18) and upstream of the earth fault current transformer (20).

15. The electrical circuit (1) according to claim 13, wherein the protection circuit further comprises a single tripping actuator (44) configured to trip a circuit breaker (8), and a first current rectifier (38), a second current rectifier (40) and a third current rectifier (42); the first current rectifier (38) being connected at input to the secondary side of the first overcurrent current transformer (16), the second current rectifier (40) being connected at input to the secondary side of the earth fault current transformer (20), the third current rectifier (42) being connected at input to the secondary side of the second overcurrent current transformer (18), the first current rectifier (38), the second current rectifier (40) and the third current rectifier (42) being connected at output to said tripping actuator (44).

16. The electrical circuit (1) according to claim 15, wherein the first overcurrent current transformer (16), the second overcurrent current transformer (18) and the earth fault current transformer (20) have each a saturation voltage of between one and two times an operating voltage of the tripping actuator.

17. The electrical circuit (1) according to claim 15, wherein the protection circuit further comprises a first resistor (50) connected in parallel at an input of the first current rectifier (38), a second resistor (52) connected in parallel at an input of the second current rectifier (40), a third resistor (54) connected in parallel at an input of the third current rectifier (42).

18. The electrical circuit (1) according to claim 13, wherein the first fuse (28A) and the second fuse (28B) are chosen from fuses having a rated current chosen from 3 Amperes, 5 Amperes and 7.5 Amperes.

19. The electrical circuit (1) according to claim 13, wherein the ratios of number of windings between the primary side and the secondary side of the first bushing current transformer (10), between the primary side and the secondary side the second bushing current transformer (12) and between the primary side and the secondary side the third bushing current transformer (14), are 50/5, 100/5 and 200/5.

20. The electrical circuit (1) according to claim 13, wherein the first overcurrent current transformer (16) is configured to clip a magnitude of the current at an output of the first bushing current transformer (10), the second overcurrent current transformer (18) is configured to clip the magnitude of the current at the output of the second bushing current transformer (12), and the earth fault current transformer (20) is configured to clip the magnitude of the current at the output of the third bushing current transformer (14).
